(19) United States
(12) Patent Application Publication
(10) Pub. No.: US 2013/0169100 A1
(43) Pub. Date: Jul. 4, 2013

(54) PERMANENT MAGNET MOTOR AND ROTOR CORE THEREOF

(71) Applicant: Jian-Feng Tsai, Kaohsiung City (TW)

(72) Inventor: Jian-Feng Tsai, Kaohsiung City (TW)

(73) Assignee: INDUSTRIAL TECHNOLOGY RESEARCH INSTITUTE, Hsinchu (TW)

(21) Appl. No.: 13/550,588

(22) Filed: Jul. 16, 2012

(30) Foreign Application Priority Data
Dec. 29, 2011 (TW) 100149622

(51) Int. Cl. H02K 1/27

(52) U.S. Cl. 310/156.38

(57) ABSTRACT

A permanent magnet (PM) motor and a rotor core thereof are provided. The PM motor includes a rotor core and a stator. The stator is disposed around the rotor core, and the rotor core is disposed along a rotation axis. The rotor core includes a magnetic core and multiple groups of PMs. The rotation axis passes through the magnetic core, and the PMs are disposed in the magnetic core around the rotation axis and in pairs. Each group of PMs includes a first PM and a second PM, which are symmetrically disposed at two opposite sides of a corresponding radial plane. Each group of PMs includes a common perpendicular line perpendicularly intersecting magnetic pole lines of the group of PMs, and a first angle exists between the common perpendicular line and the rotation axis.

### CROSS-REFERENCE TO RELATED APPLICATION

This application claims the priority benefit of Taiwan application serial no. 100149622, filed Dec. 29, 2011. The entirety of the above-mentioned patent application is hereby incorporated by reference herein and made a part of this specification.

### TECHNICAL FIELD

The disclosure relates to a permanent magnet (PM) motor and a rotor core thereof.

### BACKGROUND

Recently, PM motors are used as driving sources of most of power-driven vehicles of small and medium-power levels. Output power and torque of the PM motor is highly relevant to a magnet in the motor. A flux density can be increased by increasing the quantity of magnets or using the magnet with better magnetic properties, thereby raising the output power and torque of the motor. However, the improvement of effect by directly increasing the quantity of used magnets is restricted to limited performance if ordinary magnets are adopted.

Various designs are proposed for other purpose. For example, to the purpose of enhancing a magnetic field source, a magnet with superior magnetic properties of thicker size may replace the ordinary magnet, or an additional outer excitation source may be added in the original magnetic field. However, the above designs unavoidably increase the cost and render the structure complex. Furthermore, in the purpose of reducing magnetic path impedance, a small air gap may or a V-shaped air gap for reducing equivalent impedance may be proposed, but still suffers poor reliability and assembly interference.

An interior permanent magnet (IPM) is commonly used for concentrating magnetic flux. For example, V-shaped magnet arrangement, in a limited space, is adopted to increase a flux concentration factor. In relevant designs based on this, the flux density can also be enhanced through multi-layer and multi-pole PM arrangement, thereby increasing the output torque, but the cost is unavoidably increased.

### SUMMARY

The disclosure provides a PM motor and a rotor core thereof.

As embodied in the disclosure, a rotor core of a PM motor is provided. The rotor core is disposed along a rotation axis and includes a magnetic core and multiple groups of PMs. The rotation axis passes through the magnetic core, and the PMs are disposed in the magnetic core around the rotation axis and in pairs. Each group of PMs includes a first PM and a second PM, and the first PM and the second PM are symmetrically disposed at two opposite sides of a radial plane perpendicular to and passing through the rotation axis. Each first PM includes a first magnetic pole line, each second PM includes a second magnetic pole line, and each group of PMs includes a common perpendicular line perpendicularly intersecting the first magnetic pole line and the second magnetic pole line. A first angle exists between the common perpendicular line and the rotation axis.

The disclosure further provides a PM motor. The PM motor includes at least one rotor core and a stator. The rotor core is the foregoing rotor core of the PM motor, and the stator is disposed around the rotor core.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view of a PM motor according to an embodiment.

FIG. 2 is an exploded view of the PM motor in FIG. 1.

FIG. 3 is a schematic partial view of the PM motor in FIG. 1.

FIG. 4 is a partial top view of the rotor core of this embodiment.

FIG. 5 is a partial front view of the rotor core of this embodiment.

FIG. 6 is a schematic partial view of the magnetic core of this embodiment.

FIG. 7 is a schematic partial view of a magnetic core of another embodiment of the disclosure.

### DETAILED DESCRIPTION OF DISCLOSED EMBODIMENTS

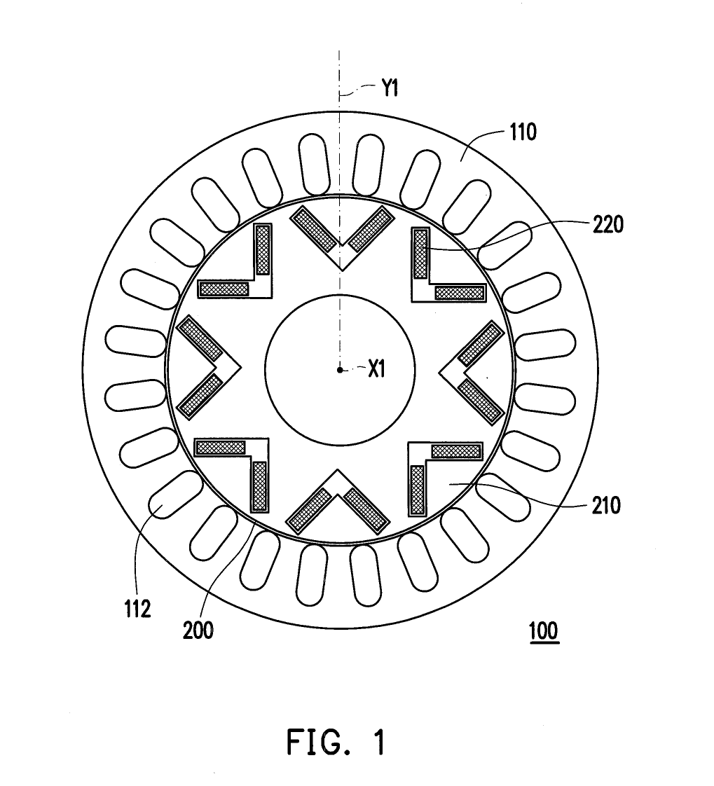

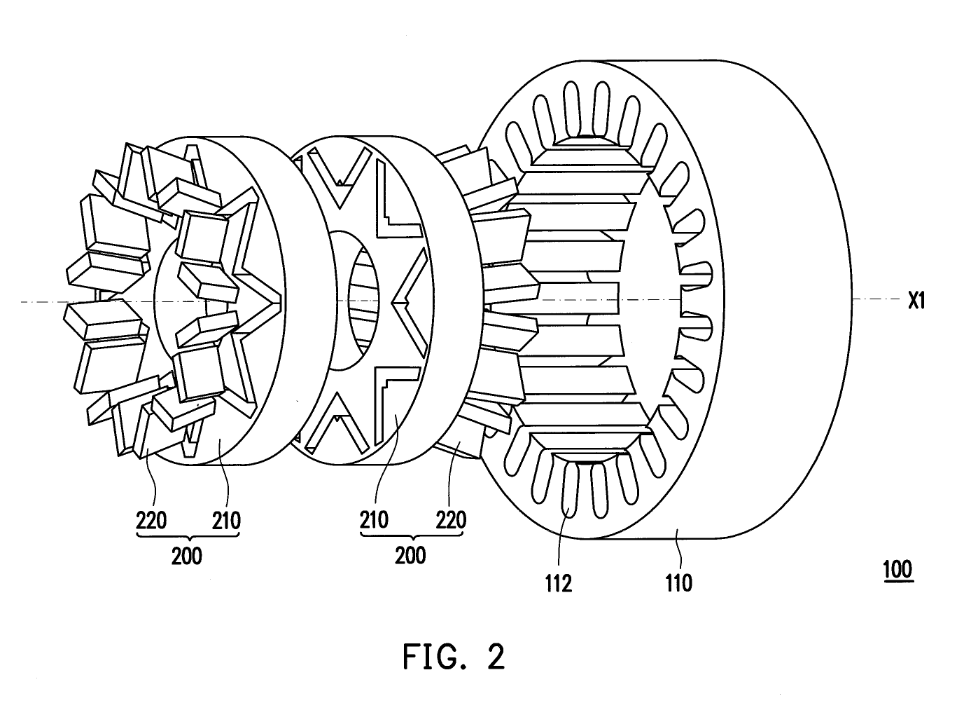

FIG. 1 is a schematic view of a PM motor according to an embodiment. FIG. 2 is an exploded view of the PM motor in FIG. 1. Referring to FIG. 1 and FIG. 2, in this embodiment, the PM motor 100 includes a rotor core 200 and a stator 110. The stator 110 is disposed around the rotor core 200 and includes a plurality of stator grooves 112 for leads to be placed in. The rotor core 200 is disposed along a rotation axis X1 and includes a magnetic core 210 and multiple groups of PMs 220. The rotation axis X1 passes through the magnetic core 210. The multiple groups of PMs 220 are disposed in the magnetic core 210 around the rotation axis X1 and in pairs, that is, when a group of PMs 220 is disposed a place in the magnetic core 210, another group of PMs 220 is disposed in a place in the magnetic core 210, wherein the two places centers on the rotation axis X1 and an angle of 180 degrees exists between the two places. In another embodiment of the disclosure, one rotor core 200 exists. However, with the disposition of the single rotor core, an axial shift may be generated due to unbalanced magnetic forces, or the flux cannot focus on the rotor core 200 effectively and is leaked in a direction of the rotation axis X1. In order to avoid the foregoing phenomenon, in this embodiment, as shown in FIG. 2, two rotor cores 200 are provided to be symmetrically disposed in the direction of the rotation axis X1.

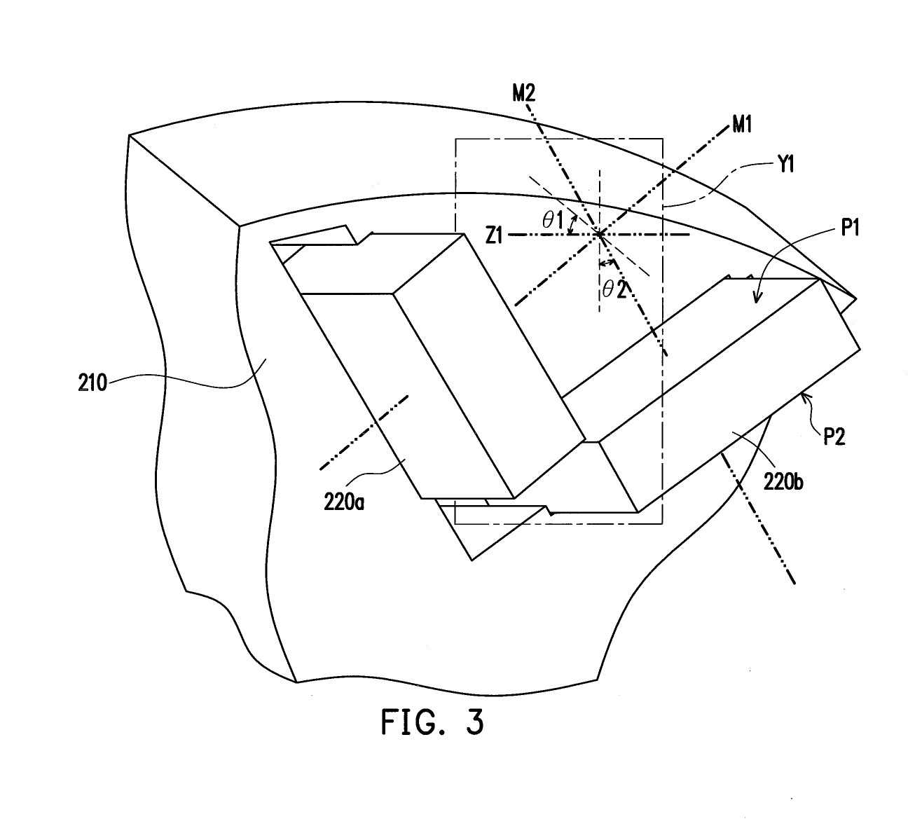

FIG. 3 is a schematic partial view of the PM motor in FIG. 1. Referring to FIG. 3, in this embodiment, each group of PMs 220 includes a first PM 220A and a second PM 220B. The first PM 220A and the second PM 220B are symmetrically disposed at two opposite sides of a radial plane Y1 perpendicular to and passing through the rotation axis X1. Each first PM 220A includes a first magnetic pole line M1, and each second PM 220B includes a second magnetic pole line M2. Here, the magnetic pole line refers to a line passing through two opposite magnetic poles (an N-pole and an S-pole) of a single PM. In this embodiment, the first PM 220A and the second PM 220B are rectangular plates, that is, the first PM 220A and the second PM 220B each includes a first plane P1 and a second plane P2 parallel to each other, and the first magnetic pole line M1 or the second magnetic pole line M2 is perpendicular to the corresponding first plane P1 and the second plane P2.

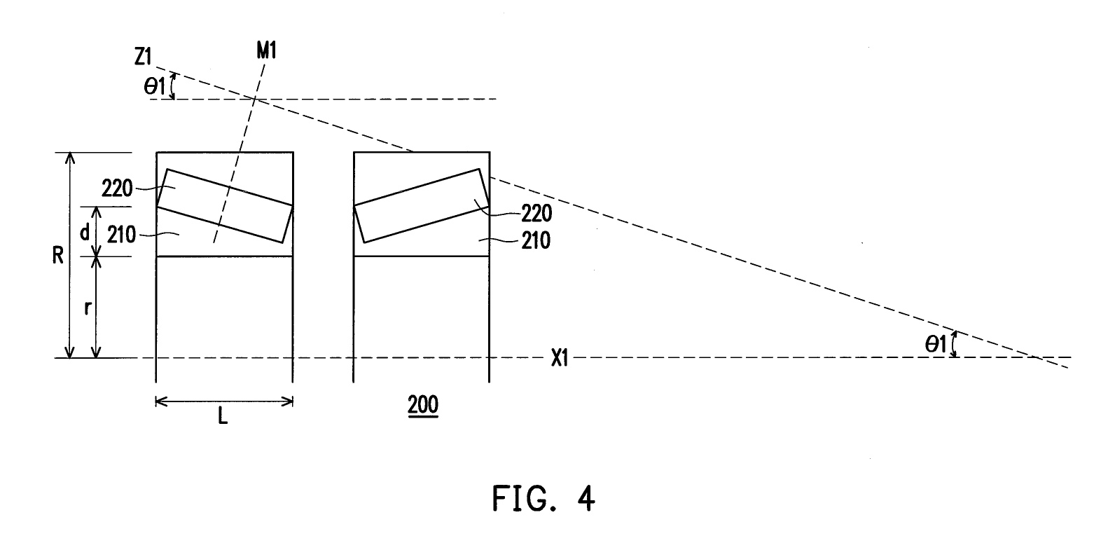

FIG. 4 is a partial top view of the rotor core of this embodiment. Referring to FIG. 3 and FIG. 4, in this embodiment, a common perpendicular line Z1 perpendicularly intersecting the first magnetic pole line M1 and the second magnetic pole line M2 exists. A first angle θ1 exists between the common perpendicular line Z1 and the rotation axis X1. In other words, it may be considered that the PM 220 is disposed on the magnetic core 210 after being rotated in an angle with respect to the rotation axis X1. Since the first angle θ1 is defined by rotating with respect to the rotation axis X1, in this embodiment, the first angle is also called an axial rotation angle. The purpose of disposing the first angle θ1 is increasing an effective area of the PM 220.

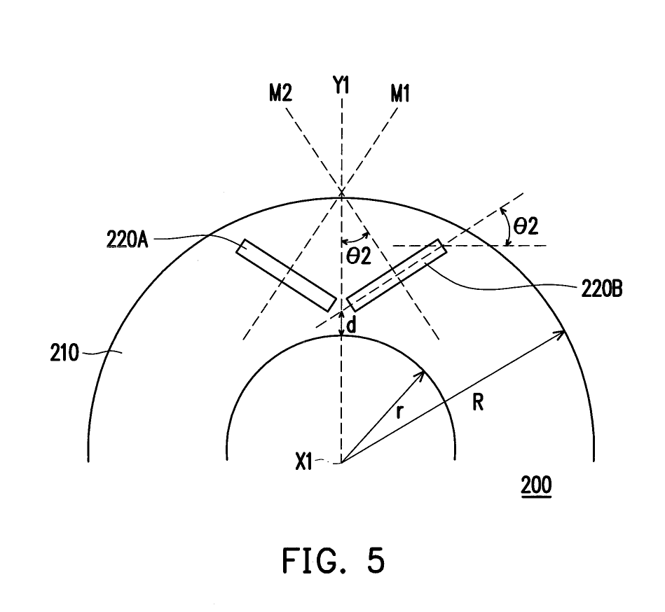

FIG. 5 is a partial front view of the rotor core of this embodiment. Referring to FIG. 3 and FIG. 5, in this embodiment, in each group of PMs 220, a second angle θ2 exists between the first magnetic pole line M1 of the first PM 220A and the corresponding radial plane Y1, and between the second magnetic pole line M2 of the second PM 220B and the corresponding radial plane Y1. In other words, it may be considered that the PMs 220 disposed at the two sides of the radial plane Y1 are disposed in the magnetic core 210 with symmetry to the radial plane Y1 after being rotated in an angle with respect to a tangent plane of the magnetic core 210, so that each group of PMs 200 is disposed in a V shape and with symmetry to the radial plane Y1, and the angle and the second angle θ2 are corresponding angles. Since each group of PMs 220 is symmetrically disposed at the two sides of the radial plane Y1, the angle between the first magnetic pole line M1 of the first PM 220A and the radial plane Y1 is equal to the angle between the second magnetic pole line M2 of the second PM 220B and the radial plane Y1. Since the second angle θ2 is considered to be rotated with respect to the tangent plane, in this embodiment, the second angle is also called a tangential rotation angle. The disposition of the second angle θ2 can also increase the effective area of the PM 220. In this embodiment, the first angle θ1 and the second angle θ2 may be used in cooperation. Moreover, in this embodiment, the second angle θ2 is supposed to be greater than 0 degree and substantially less than 60 degrees.

Referring to FIG. 4 and FIG. 5, in this embodiment, the magnetic core 210 of the PM motor 100 is tubular. Relevant sizes of the magnetic core 210 is marked with variables, an inner diameter of the magnetic core 210 may be defined as r, an outer diameter of the magnetic core 210 may be defined as R, and a length of the magnetic core 210 may be defined as L. The multiple groups of PMs 220 are disposed at the two opposite sides of the rotation axis X1 in pairs, and N pairs of PMs 220 exist. It should be noted that, a pair of PMs 220 represents two groups of PMs 220 disposed at the two opposite sides of the rotation axis X1, that is, each pair of PMs 220 includes two groups of PMs 220, which are disposed in two places in the magnetic core 210, wherein the two places centers on the rotation axis X1 and the angle of 180 degrees exists between the two places. Accordingly, the first angle is defined asθ1 and the second angle is defined asθ2. A range of the first angle is 0<θ1<min(60, tan⁻¹(d/L)), that is, the first angle is greater than 0 degree and substantially less than a minimum of 60 degrees and tan⁻¹(d/L) degrees, wherein d is regarded as a distance between a portion of the PM 220 close to an outer side of the magnetic core 210 and an inner tube surface of the magnetic core 210. As shown in FIG. 5, the distance is defined as: d=[1−sin(θ2)]⁻¹×{r[sin(θ2)−1]+R[cos(180/N)−sin(θ2)]}. It can be known from this that, the first angle θ1 can be varied according to a geometric size of the magnetic core 210 and the arrangement of the PM 220.

In another embodiment of the disclosure, the first angle is defined asθ1 as mentioned above. The first angle θ1 may be further limited as follows: θ1=min(30, tan⁻¹(d/L)), that is, an optimal angle of the first angle is a minimum of 30 degrees and tan⁻¹(d/L) degrees. As stated above, the first angle θ1 can be varied as according to a geometric size of the magnetic core 210 and the arrangement of the PM 220, but in this embodiment, the first angle θ1 is further limited, and a more accurate value of the first angle θ1 can be provided.

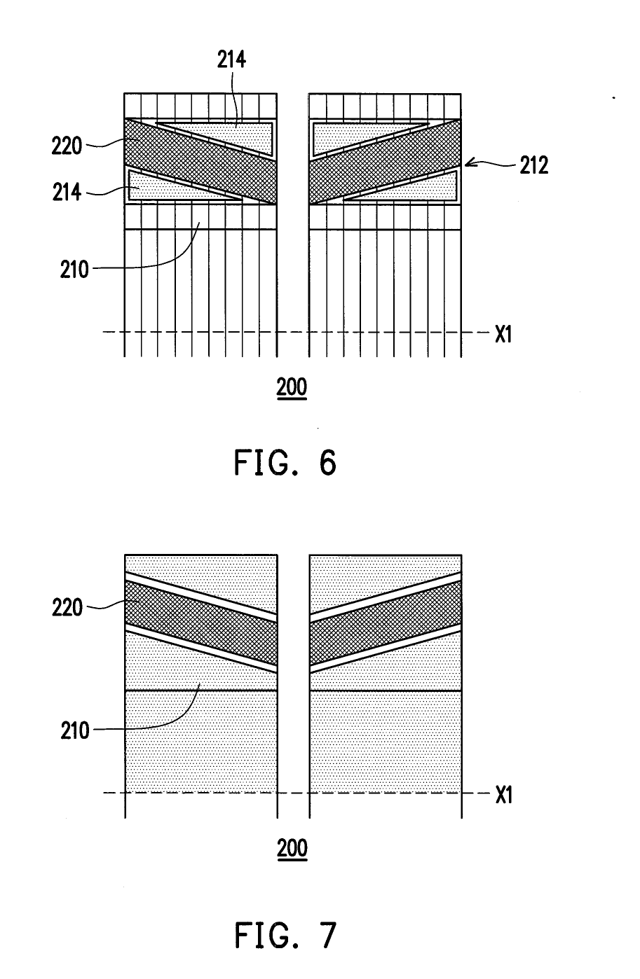

FIG. 6 is a schematic partial view of the magnetic core of this embodiment. Referring to FIG. 6, this disclosure provides a rotor core 200 of a PM motor. The rotor core 200 includes a magnetic core 210 and multiple groups of PMs 220. The PM 220 is disposed in the magnetic core 210, so the magnetic core 210 includes a plurality of accommodating holes 212 for accommodating the PM 220. In this embodiment, the magnetic core 210 may be a plurality of circular discs stacked with one another. The circular disc includes a plurality of openings for forming the accommodating holes 212 after being stacked. However, since the PM 220 includes a rotation angle, it is difficult and costly to fabricate the openings complying with the rotation angle of the PM 220 in the magnetic core 210 formed by stacking the circular discs.

Accordingly, in this embodiment, the accommodating hole 212 of a large size is disposed on the circular disc so that the PM 220 with the rotation angle can be accommodated in the accommodating hole 212. However, when the PM 220 with the rotation angle is placed in the accommodating holes 212 of the magnetic core 210 formed by the circular discs, a lot of gaps exist in the accommodating holes 212.

In order to solve the problem, in this embodiment, complementary blocks 214 are used to fill the gaps in the accommodating holes 212. In particular, in this embodiment, the magnetic core 210 with large-sized accommodating holes 212 is fabricated by using the circular discs, and the complementary blocks 214 are provided to fill the gap between the PMs 220 and the corresponding accommodating holes 212. In this embodiment, a material of the complementary blocks 214 is isotropic magnetic conducting powder; while in another embodiment of the disclosure, the material of the complementary block 214 may be another suitable material. Accordingly, in this embodiment, the complementary blocks 214 are disposed to solve the problem of the gaps occurring when the PM 220 with the rotation angle is placed in the magnetic core 210 formed by the circular discs.

FIG. 7 is a schematic partial view of a magnetic core of another embodiment of the disclosure. Referring to FIG. 7, in this embodiment, the magnetic core 210 is fabricated by using isotropic magnetic conducting powder instead of circular discs, wherein the PM 220 with the first angle θ1 and the second angle θ2 can be placed in the magnetic core 210 without preforming the aforementioned accommodating hole 212 and disposing the complementary block 214 for filling gaps between the magnetic core 210 and the PM 220. In other words, this embodiment provides no gap to be filled with the complementary block 214 and gives no limitation to the disposition manner of the PM 220.

To sum up, the disclosure provides a PM motor and a rotor core applicable to the PM motor, wherein the disposition manner of the PMs in the rotor core of the PM motor is modified to increase the effective area of the PMs. In other words, in the disclosure, the rotation angle, for example the axial rotation angle between the common perpendicular line of magnetic pole lines of the each group of PMs and the rotation axis of the PM motor, or the tangential rotation angle between the magnetic pole lines of each group of PMs and corresponding radial planes. Through the aforementioned disposition of the PMs, the effective area of the permanent magnet can be increased to increase a flux density and thereby raise output power and torque of the motor.

Besides, in order to dispose the PMs with the rotation angle in the magnetic core, in the disclosure, the magnetic core may be formed by the plurality of circular discs stacked with one another, and the accommodating hole is formed in the magnetic core for accommodating the PMs with the rotation angle. Complementary blocks fabricated by the isotropic magnetic conducting powder are used to fill the gaps between the PMs and the accommodating hole of the magnetic core. Furthermore, in the disclosure, the magnetic core may also be fabricated by using the isotropic magnetic conducting powder, and the PM with the rotation angle is placed in the magnetic core. When the magnetic core is fabricated by using the isotropic magnetic conducting powder, the accommodating hole fitting with the PM can be formed directly in a forming process, the complementary blocks are not required, and there gives no limitation to the disposition manner of the PMs.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A permanent magnet (PM) motor, comprising:
at least one rotor core, disposed along a rotation axis, each of the rotor cores comprises:
a magnetic core, wherein the rotation axis passes through the magnetic core; and
multiple groups of PMs, disposed in the magnetic core around the rotation axis and in pairs, wherein each group of PMs comprises a first PM and a second PM, the first PM and the second PM are symmetrically disposed at two opposite sides of a radial plane perpendicular to and passing through the rotation axis, each first PM comprises a first magnetic pole line, each second PM comprises a second magnetic pole line, each group of PMs comprises a common perpendicular line perpendicularly intersecting the first magnetic pole line and the second magnetic pole line, and a first angle exists between the common perpendicular line and the rotation axis; and
a stator, disposed around the at least one rotor core.

2. The PM motor according to claim 1, wherein, in each group of PMs, a second angle exists between the first magnetic pole line of the first PM and the corresponding radial plane, and between the second magnetic pole line of the second PM and the corresponding radial plane.

3. The PM motor according to claim 2, wherein the second angle is greater than 0 degree and substantially less than 60 degrees.

4. The PM motor according to claim 1, wherein the magnetic core comprises a plurality of accommodating holes accommodating the PMs.

5. The PM motor according to claim 4, wherein each of the rotor cores further comprises a plurality of complementary blocks filling gaps between the PMs and the corresponding accommodating holes respectively.

6. The PM motor according to claim 5, wherein a material of the complementary blocks comprises isotropic magnetic conducting powder.

7. The PM motor according to claim 1, wherein a material of the magnetic core comprises isotropic magnetic conducting powder.

8. The PM motor according to claim 4, wherein the magnetic core comprises a plurality of circular discs stacked with one another, and each of the circular discs comprises a plurality of corresponding openings for forming the accommodating holes after being stacked.

9. The PM motor according to claim 1, wherein the magnetic core is tubular, an inner diameter of the magnetic core is r, an outer diameter of the magnetic core is R, a length of the magnetic core is L, the multiple groups of PMs are disposed at the two opposite sides of the rotation axis in pairs, and N groups of PMs is provided with the first angle defined as θ1 and the second angle defined as θ2, wherein
0<θ1<min(60, tan⁻¹(d/L)); and
d=[1−sin(θ2)]⁻¹×{r[sin(θ2)−1]+R[cos(180/N)−sin(θ2)]}.

10. The PM motor according to claim 9, wherein θ1=min(30, tan⁻¹(d/L)).

11. The PM motor according to claim 1, wherein each first PM or second PM is a rectangular plate comprising a first plane and a second plane parallel to each other, and the first magnetic pole line or the second magnetic pole line is perpendicular to the corresponding first plane and the corresponding second plane.

12. The PM motor according to claim 1, wherein the number of the at least one rotor core is two, and the two rotor cores are symmetrically disposed in a direction of the rotation axis.

13. A rotor core of a permanent magnet (PM) motor, disposed along a rotation axis, the rotor core comprising:
a magnetic core, wherein the rotation axis passes through the magnetic core; and
multiple groups of PMs, disposed in the magnetic core around the rotation axis and in pairs, wherein each group of PMs comprises a first PM and a second PM, the first PM and the second PM are symmetrically disposed at two opposite sides of a radial plane perpendicular to and passing through the rotation axis, each first PM comprises a first magnetic pole line, each second PM comprises a second magnetic pole line, each group of PMs comprises a common perpendicular line perpendicularly intersecting the first magnetic pole line and the second magnetic pole line, and a first angle exists between the common perpendicular line and the rotation axis.

14. The rotor core of a PM motor according to claim 13, wherein, in each group of PMs, a second angle exists between the first magnetic pole line of the first PM and the corresponding radial plane, and between the second magnetic pole line of the second PM and the corresponding radial plane.

15. The rotor core of a PM motor according to claim 14, wherein the second angle is greater than 0 degree and substantially less than 60 degrees.

16. The rotor core of a PM motor according to claim 13, wherein the magnetic core comprises a plurality of accommodating holes accommodating the PMs.

17. The rotor core of a PM motor according to claim 16, further comprising a plurality of complementary blocks filling gaps between the PMs and the corresponding accommodating holes respectively.

18. The rotor core of a PM motor according to claim 17, wherein a material of the complementary blocks comprises isotropic magnetic conducting powder.

19. The rotor core of a PM motor according to claim 13, wherein a material of the magnetic core comprises isotropic magnetic conducting powder.

20. The rotor core of a PM motor according to claim 16, wherein the magnetic core comprises a plurality of circular discs stacked with one another, and each of the circular discs comprises a plurality of corresponding openings for forming the accommodating holes after being stacked.

21. The rotor core of a PM motor according to claim 13, wherein the magnetic core is tubular, an inner diameter of the magnetic core is r, an outer diameter of the magnetic core is R, a length of the magnetic core is L, the multiple groups of PMs are disposed at the two opposite sides of the rotation axis in pairs, and N groups of PMs is provided with the first angle defined as θ1 and the second angle defined as θ2, wherein
0<θ1<min(60, tan⁻¹(d/L)); and
d=[1−sin(θ2)]⁻¹×{r[sin(θ2)−1]+R[cos(180/N)−sin(θ2)]}.

22. The rotor core of a PM motor according to claim 21, wherein θ1=min(30, tan⁻¹(d/L)).

23. The rotor core of a PM motor according to claim 13, wherein each first PM or second PM is a rectangular plate comprising a first plane and a second plane parallel to each other, and the first magnetic pole line or the second magnetic pole line is perpendicular to the corresponding first plane and the corresponding second plane.
